(19) United States
(12) Patent Application Publication
(10) Pub. No.: US 2023/0016216 A1
(43) Pub. Date: Jan. 19, 2023

(54) NON-METALLIC WEAR BANDS FOR OILFIELD RODS AND TUBULARS, AND METHODS OF FORMING SAME

(71) Applicant: Russel MOORE, Drayton Valley (CA)

(72) Inventor: Russel MOORE, Drayton Valley (CA)

(21) Appl. No.: 17/785,891

(22) PCT Filed: Dec. 20, 2020
(86) PCT No.: PCT/CA2020/000137

§ 371 Date: Jun. 15, 2022

Related U.S. Application Data
(60) Provisional application No. 63/026,868, filed on May 19, 2020.
(60) Provisional application No. 62/951,988, filed on Dec. 20, 2019.

(51) Int. Cl. E21B 17/10; F16C 33/20; F16C 33/28; F16L 57/06

(52) U.S. Cl. CPC E21B 17/10; F16C 33/28; F16C 33/201; F16L 57/06; F16C 2352/00

(57) ABSTRACT

Upset oilfield tubing or upset pump rods are protected from abrasive wear by non-metallic circumferential wear bands applied to the upset portions of the tubing or rods and/or at selected locations along non-upset portions of the tubing or rods between the upset ends. The wear bands may be formed from selected polymeric materials including thermal polyurethane, polyphthalamide PTFE blends, and polyether ether ketone (PEEK), injection-molded onto suitably prepared circumferential surfaces of the tubing or rods. The wear bands may incorporate stainless steel mesh or other reinforcing materials embedded in the injection-molded polymeric material.

### FIELD

The present disclosure relates in general to methods for preventing or protecting against abrasive wear of steel tubing strings and pump rod strings caused by rotational and/or sliding contact against the bore of steel casing strings or production tubing strings enclosing the tubing strings or rod strings. The present disclosure relates in particular to methods for preventing or protecting against abrasive wear in tubing and rod strings made up from tubing or rod sections having ends that are formed with external upsets.

### BACKGROUND

Many common oilfield operations, including the drilling and casing of oil and gas wells, involve the assembly and use of tubular strings made up from sections (or “joints”) of steel pipe that are typically 20 to 30 feet in length and have generally uniform outside and inside diameters. The pipe joints typically are externally threaded at each end, and are joined end-to-end using internally-threaded and comparatively thin-walled cylindrical couplings. The result is a tubing string having a generally uniform outside diameter (O.D.) along its length except for small increases in O.D. at the couplings between adjacent joints in the string.

The external threading at the ends of the pipe joints making up tubing strings, as described above, reduces the effective structural cross-section of the tubing at those locations, such that the connections between adjacent pipe joints are the structurally weakest zones in such tubing strings. This is not a problem for most conventional uses of such tubing strings, which will still have adequate structural strength to withstand the various loads that they will be subjected to during normal operations, in spite of the reduced structural cross-section at the tubing connections.

However, there are other oilfield operations that require the use of tubing strings having greater structural strength than can be provided by conventional tubing strings as described above. One increasingly common example of this need for structurally stronger tubing strings is found in hydraulic fracturing operations (commonly referred to as “fraccing”). Fraccing operations are most commonly carried out in a “deviated” wellbore having a vertical leg that extends to a selected depth and then transitions to a horizontal leg, using directional drilling techniques.

Both the vertical and horizontal legs of the deviated wellbore, as well as the large-radius transition section between the vertical and horizontal legs, are lined with a tubular steel casing string. Most commonly, the casing string is inserted into the wellbore upon completion of drilling, and then cemented into place by pumping a cement slurry into the annular space between the casing and the wellbore. Alternatively, in so-called “drilling with casing” (DWC) operations, the drill string is made up from casing-size tubing and remains in the wellbore after drilling to serve as permanent casing, thus eliminating the need for the separate operation of running a casing string into the wellbore after completion of drilling.

To enhance the flow of petroleum fluids (such as crude oil and natural gas) out of “tight” subterranean formations (such as shale formations), one or more selected sections of the horizontal leg of the cased wellbore (which can be several thousand feet long) may be isolated using “packers” or “frac plugs”, so that “frac fluids” can be injected under very high pressure into the isolated sections, and outward therefrom into the surrounding formation through slots or perforations in the steel casing or liner. The hydraulic pressures thus introduced into the formation create fractures and fissures through which “trapped” fluids can flow out of the formation and into the wellbore.

Before such flow of fluids into the wellbore can occur, the frac plugs have to be removed (or “drilled out”), using a downhole tool designed for that purpose and run into the wellbore at the end of a tubing string that is rotated at surface to activate the downhole tool. Tubing strings used for this purpose must be capable of withstanding comparatively high structural loads, particularly including torsional loads. For that reason, such tubing strings are commonly made up from tubing joints having an external upset (i.e., increased O.D.) at each end, such that the full structural capacity of the “base” tubing (i.e., between the upsets) is maintained through the connections between adjacent joints, because the increased O.D. at the upsets compensates for the material removed by threading. One end (referred to as the “box end”) of each joint of “upset” tubing is internally threaded, and the other end (referred to as the “pin end”) is externally threaded, so that the joints can be directly connected to each other without need for separate couplings as in conventional drill strings and casing strings.

A problem that arises with upset tubing strings used for drilling out frac plugs is that the larger-O.D. upsets will ride against the bore of the casing as the strings are rotated and moved axially within the casing, and this steel-to-steel contact can cause abrasive wear of the upsets, and corresponding loss of structural strength at locations in the string where it is most needed. Such loss of structural strength is particularly undesirable in the curved transition zone between the vertical and horizontal legs of the wellbore, where flexural loads in the upset tubing string tend to be highest, and torsional loads are higher due to frictional restraint induced by contact between the upset tubing string and the casing bore in this zone.

In order to prevent or mitigate these problems, it is common for the upset on at least one end of each upset tubing joint to be “hard banded” -i.e., protected by a circumferential band of metal built up to a selected thickness along a selected length of the upset, such as by means of MIG (metal inert gas) welding or other suitable welding procedure. The material used for hard banding is typically an alloy having significantly greater abrasion resistance than the base metal of the tubing, so that it will be worn down at a much lesser rate than unprotected tubing upsets. In this way, hard banding extends the service life of upset tubing strings, although it also has the residual disadvantage of causing increased wear in the bore of the typically carbon steel casing in which the upset tubing string is being used. Moreover, hard banding has the additional drawback of being very expensive.

For the foregoing reasons, there is a need for methods and means for protecting upset tubing strings against abrasive wear at a lower cost than for conventional hard banding, while extending the service life of upset tubing strings at least as long as can be expected with hard banding, and preferably without causing increased casing wear.

### BRIEF SUMMARY

The present disclosure teaches methods and means for protecting upset tubing and upset pump rods from abrasive wear by means of non-metallic circumferential wear bands applied to the upset portions of the tubing or rods and/or at selected locations along the non-upset portions of the tubing or rods between the upset ends. The inventor realized that wear bands made from synthetic, non-metallic materials (referred to herein as “soft banding”) would be less costly than conventional hard banding, and also would reduce rotational and sliding friction between the tubing (or rods) and the casing (or production tubing) in which they are being rotated and/or moved axially within, with significant resultant benefits (for example, reduced torque loads acting on the tubing string).

However, known synthetic non-metallic materials that could be expected to result in reduced friction if used for wear bands also would typically be expected to experience considerable abrasive wear due to rotational and/or sliding contact with metal surfaces such as the bore of steel casing or production tubing. If wear bands using such known non-metallic materials would have the desirable effects of protecting the upset ends of the tubing or rod joints against abrasive wear while significantly reducing friction and torque, but would themselves be prone to abrasive wear sufficient to make their effective service life considerably shorter than for hard banding, they might not offer any significant net benefit or advantage over hard banding.

To explore the potential feasibility of using “soft banding” for upset tubing (and rod), the inventor constructed a testing apparatus in which a soft-banded steel tubing section could be simultaneously rotated and reciprocated in sliding contact with the bore of a tubular steel casing, under conditions simulating the actual operational conditions for a tubing string rotating and sliding within the curved transition section of a cased deviated wellbore. More specifically, the testing apparatus used hydraulic jacks to apply lateral loads to a soft-banded test piece rotating and sliding in contact with the bore of a “casing” component mounted in the testing apparatus, to generate frictional loads between the soft banding and the casing bore corresponding to those that would be generated in actual field operations. To further simulate actual field conditions, the test apparatus provided for a continuous flow of water-sand slurry at the interface between the soft banding and the casing bore surface, thereby simulating conditions that can be expected in actual field operations. In all test runs, the water-sand slurry contained at least 1% sand by weight.

The inventor used this testing apparatus to test circumferential soft banding made with a variety of different synthetic materials. Test pieces were made from lengths of 2.875“ (O.D.) pipe prepared by wire brushing to remove all mill scale and other contaminants from the circumferential surface area to be soft banded. A bonding agent was applied to the prepared areas on each test piece, and then a wear band made from a selected synthetic material, and having a selected radial thickness and axial length, was formed over the circumferential area having the bonding agent, by means of injection molding. Each wear band was formed with a circumferential groove having a radial depth of 0.125” to facilitate measurement of wear (i.e., reduction of radial thickness). The test pieces were then tested in the testing apparatus, under simulated field conditions as previously described, for selected time intervals, with the test pieces in constant rotating and reciprocating contact against the bore of a casing component comprising a split (i.e., semi-cylindrical) length of 5.50”(O.D.) carbon steel tubing. After each test, wear was measured on both the soft banding and the casing component.

The soft-banded test pieces were also pull-tested to determine the axial loads at which the bond between the wear band and the 2.875” pipe failed, resulting in undesirable axial sliding of the soft banding relative to the pipe.

To enable meaningful comparison of the results of the soft banding test, hard-banded test pieces were also tested using the sane test apparatus, to provide “benchmark” data for assessing the relative performance of the soft-banded test pieces in terms of casing wear.

### BRIEF DESCRIPTION OF THE DRAWINGS

Embodiments will now be described with reference to the accompanying Figures, in which numerical references denote like parts, and in which:

FIG. 1 is a conceptual, not-to-scale, vertical cross-section through the curved transition region between the vertical and horizontal legs of a cased deviated wellbore, with a prior art “hard-banded” upset tubing string disposed within the wellbore casing.

FIG. 1A is an enlarged sectional view of hard banding on an upset box end in an upset tubing string as in FIG. 1, in rotational and/or siding contact with the bore surface of the casing as the upset tubing string is rotated and/or axially moved within the casing string.

FIG. 2 is an isometric view of the box end of a joint of upset tubing, with “soft banding” applied at alternative locations in accordance with the present disclosure.

FIG. 2A is a cross-section through the soft-banded upset box end of the upset tubing shown in FIG. 2.

FIG. 2B is a cross-section through a soft-banded non-upset region of the upset tubing shown in FIG. 2.

FIG. 3 is a conceptual, not-to-scale, vertical cross-section through the curved transition region of a deviated wellbore similar to FIG. 1, but with an upset tubing string having soft banding generally as shown in FIG. 2.

FIG. 3A is an enlarged sectional view of soft banding on an upset box end in an upset tubing string as in FIG. 3, in rotational and/or siding contact with the bore surface of the casing.

FIG. 4 is an isometric view of the box end of a joint of upset pump rod, with soft banding applied at alternative locations in accordance with the present disclosure.

FIG. 4A is a cross-section through the soft-banded upset box end of the upset pump rod shown in FIG. 4.

FIG. 4B is a cross-section through a soft-banded non-upset region of the upset pump rod shown in FIG. 4.

FIG. 5 is an isometric detail showing mesh reinforcement placed around a piece of tubing in preparation for application of soft banding in accordance with the present disclosure.

FIG. 6 is a transparent isometric detail of the tubing shown in FIG. 5, subsequent to the application of soft banding in accordance with the present disclosure, with the mesh reinforcement embedded therein.

FIG. 6A is cross-section through the mesh-reinforced soft-banded tubing generally as shown in FIG. 6, but with the reinforcing mesh being of woven style.

### DETAILED DESCRIPTION

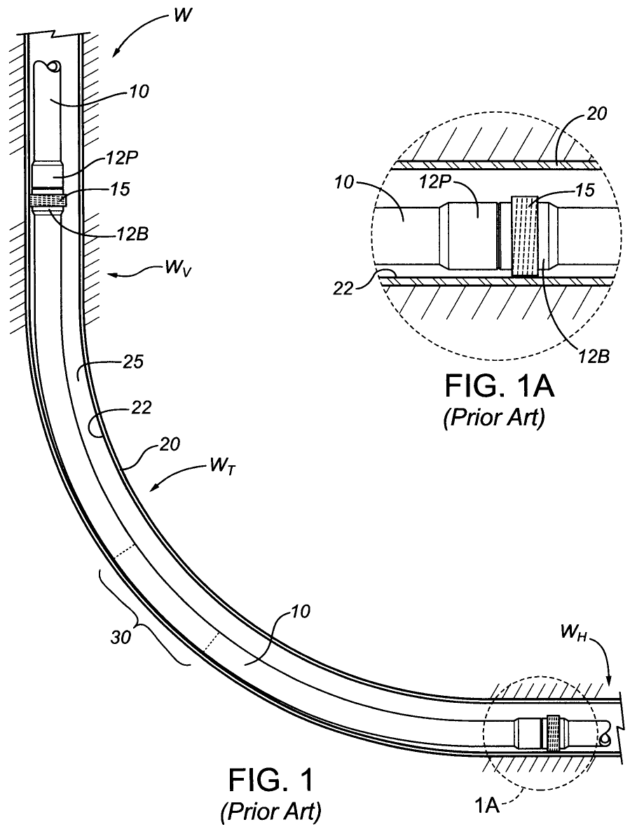

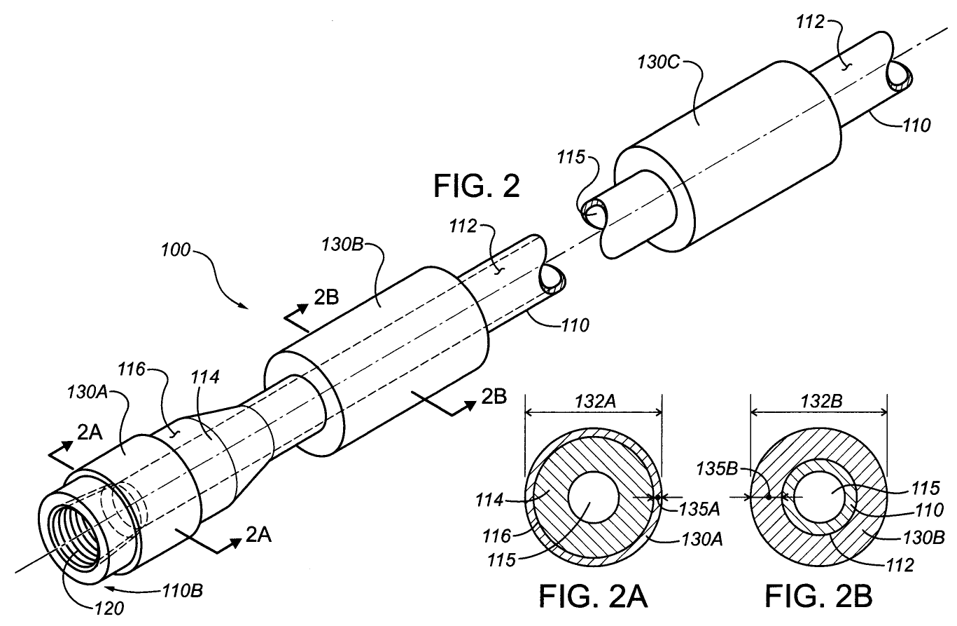

FIG. 1 is a conceptual depiction of the curved transition region W_{T} between vertical and horizontal legs Wv and W_{H} of a deviated wellbore W, which is shown lined with a casing string 20 having an interior bore surface 22. A string of upset tubing joints 10 is shown disposed within the bore of casing string 20, forming an annular space 25 between the upset tubing string and bore surface 22 of casing string 20. Each upset tubing joint 10 has an upset “box end” 12B (with internal threading 120 as shown in FIG. 2) and an upset “pin end” 12P (with external threading, not shown). As depicted in FIGS. 1 and 1A, conventional hard banding 15 has been applied around the upset box end 12B of each upset tubing joint 10. Alternatively, the hard banding could be applied to upset pin end 12P (typically there would not be any need to hard-band both the box end and the pin end at the connection between two upset tubing joints 10).

FIG. 1 shows a single upset tubing joint 10 extending through curved transition section W_{T} of wellbore W, but this is a simplification solely for purposes of illustration. In an actual installation, the transition section of the upset tubing string would be hundreds of feet long, and therefore would include many of joints of upset tubing.

As conceptually illustrated in FIGS. 1 and 1A, the string of upset tubing joints 10 will come into contact with bore surface 22 of casing string 20 as the upset tubing string moves axially and/or rotationally within casing 20. At connections between joints 10 in the upset tubing string, only the hard banding 15 on the upset box ends 12B comes into contact with casing bore surface 22, due to the hard banding having a sufficiently larger O.D. than upset ends 12B and 12P of the tubing 10. However, hard banding 15 has the deleterious effect of causing abrasive wear on bore surface 22 of the softer carbon-steel casing 20.

FIG. 1 also conceptually illustrates the further problem that non-upset medial regions 30 of upset tubing joints 10 passing through curved transition region W_{T} of wellbore W may come into rotational and/or sliding contact with bore surface 22 of casing 20, which can result in deleterious wear to both the upset tubing 10 and casing 20, as well as additional friction that increases the torque required to rotate the tubing string. The application of hard banding in medial regions 30 of the upset tubing joints 10 could mitigate this problem, but in order to be effective such medial-region hard banding would need to be applied over a significant length of the tubing and/or have a significant radial thickness, and therefore would be quite expensive compared to hard banding applied on the tubing upsets.

FIGS. 2, 2A, and 2B illustrate an embodiment 100 of a soft-banded upset tubing joint in accordance with the present disclosure. In the illustrated embodiment, reference number 130A denotes soft banding applied on a circumferential surface 116 of an upset section 114 of a box end 110B of a tubing joint 110 having a bore 115. Reference number 130B denotes soft banding applied on a circumferential surface 112 of a non-upset portion of tubing joint 110 adjacent to upset box end section 114, as an alternative to soft banding 130A on upset box end section 114. One advantage of this alternative is that the axial length of soft banding 130B can be comparatively large if desired, whereas the axial length of soft banding 130A is restricted by the axial length of upset box end section 114. The greater axial length available with soft banding 130B enables the provision of an ample interface area between the soft banding 130B and non-upset circumferential tubing surface 112 for application of a bonding agent, thus increasing the differential axial force that would have to be applied to break the bond between the soft banding 130B and non-upset circumferential tubing surface 112, with the undesirable result of the soft banding 130B sliding axially relative to tubing joint 110.

Although FIG. 2 shows both soft banding 130A and soft banding 130B, this is for convenience of illustration only, as there typically would not be any need to apply soft banding to an upset end of tubing 110 and also to a non-upset region of tubing 110 adjacent to the upset end.

Reference number 130C denotes soft banding applied to non-upset circumferential tubing surface 112. The soft banding denoted by reference number 130C is shown as being generally similar to soft banding 130B, except that reference number 130C is intended to denote soft banding applied to a medial region of tubing joint 110 to prevent metal-to-metal contact between non-upset regions of the tubing string and casing 20 (as previously discussed with reference to FIG. 1).

Having reference to FIGS. 2A and 2B, when soft banding 130B is applied to surface 112 adjacent to upset end 114 of tubing joint 110, instead of soft banding 130A on upset end 114, the O.D. 132B of soft banding 130B will typically need to be at least as great as what the O.D. 132A of soft banding 130A would need to be, in order to ensure that surface 116 on upset end 114 will remain clear of casing bore surface 22. The radial thickness 135B of soft banding 130B thus will need to be considerably greater than the radial thickness 135A of soft banding 130A would need to be, and therefore soft banding 130B will require a greater amount of material per unit of axial length than soft banding 130A. However, this typically will not be a significant consideration, as the materials used for soft banding in accordance with the present disclosure represent a comparatively small proportion of the total cost of the soft banding process, which still can be expected to be considerably less than the cost of hard banding.

In FIG. 2, the length and O.D. of medial soft banding 130C are shown as generally corresponding to the length and O.D. of soft banding 130B adjacent to upset box end section 114; however, this is by way of example only. The O.D. of medial soft banding 130C could be considerably less than for soft banding 130B, which, as discussed above, requires a greater O.D. (and radial thickness) to ensure clearance of the upset tubing ends from casing bore surface 22. As well, the axial lengths of soft banding 130B and 130C can be varied as appropriate to suit operational conditions.

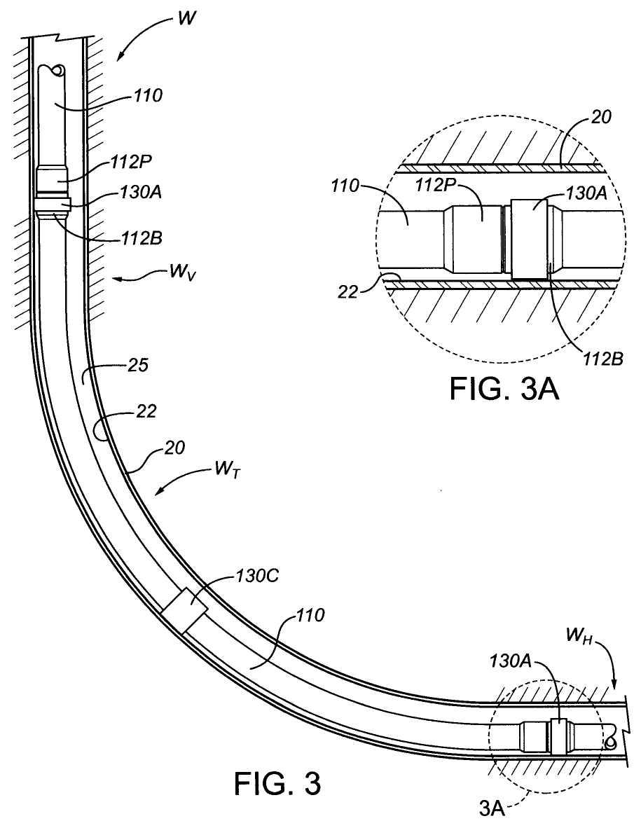

FIG. 3 conceptually illustrates a string of upset tubing joints 110 disposed within casing string 30, with soft banding 130A on upset box ends 112B, and with soft banding 130C in a non-upset medial region of each tubing joint to prevent such medial regions from coming into wear-inducing contact with casing bore surface 22 in curved transition region W_{T} of deviated wellbore W.

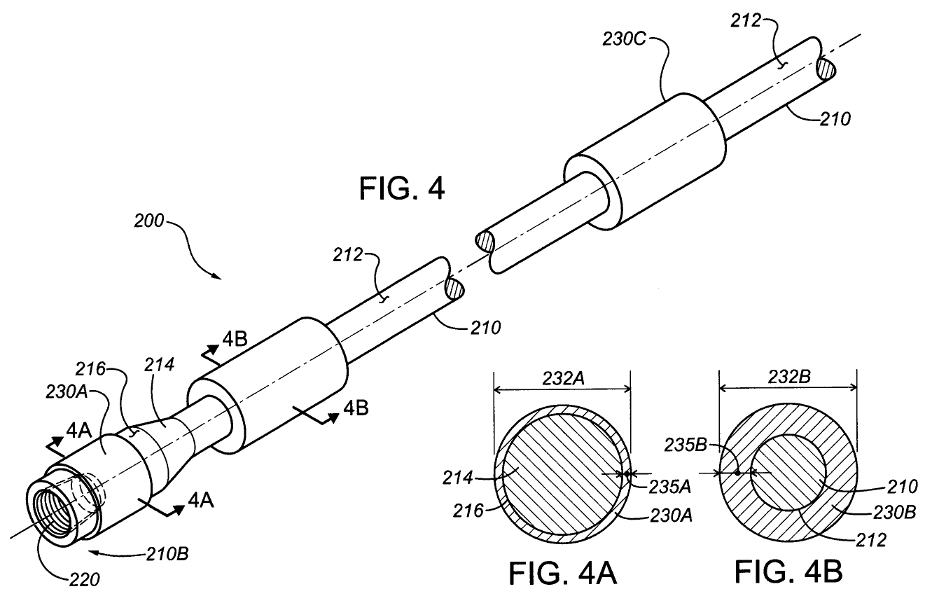

FIGS. 4, 4A, and 4B illustrate an embodiment 200 of a soft-banded joint 210 of upset solid pump rod (also referred to as a “sucker rod”), but are otherwise similar to FIGS. 2, 2A, and 2B, respectively. More specifically, reference number 230A denotes soft banding applied on a circumferential surface 216 of an upset section 214 of a box end 210B of a pump rod joint 210. Reference number 230B denotes soft banding applied on a circumferential surface 212 of a non-upset portion of pump rod joint 210 adjacent to upset box end section 214, as an alternative to soft banding 230A on upset box end section 214. Although FIG. 4 shows both soft banding 230A and soft banding 230B, this is for convenience of illustration only, as there typically would not be any need to apply soft banding to an upset end of pump rod joint 210 and also to a non-upset region of pump rod joint 210 adjacent to the upset end.

Reference number 230C denotes soft banding applied to circumferential rod surface 212. The soft banding denoted by reference number 230C is shown as being generally similar to soft banding 230B, except that reference number 230C is intended to denote soft banding applied to a medial region of pump rod joint 210 to prevent metal-to-metal contact between non-upset regions of the pump rod string and the bore of a production tubing string in which the pump rod string is being rotated and/or reciprocated.

Having reference to FIGS. 4A and 4B, when soft banding 230B is applied to surface 212 adjacent to upset box end section 214 of pump rod joint 210, instead of soft banding 230A on upset end 214, the O.D. 232B of soft banding 230B will typically need to be at least as great as what the O.D. 232A of soft banding 230A would need to be, in order to ensure that surface 216 on upset box end section 214 will remain clear of the production tubing bore surface. The radial thickness 235B of soft banding 230B thus will need to be considerably greater than the radial thickness 235A of soft banding 230A would need to be, and therefore soft banding 230B will require a greater amount of material per unit of axial length than soft banding 230A.

In FIG. 2, the length and O.D. of medial soft banding 230C are shown as generally corresponding to the length and O.D. of soft banding 230B adjacent to upset box end section 214; however, this is by way of example only. The O.D. of medial soft banding 230C could be considerably less than for soft banding 230B, which, as discussed above, requires a greater O.D. (and radial thickness) to ensure clearance of the upset pump rod ends from the production tubing bore surface. As well, the axial lengths of soft banding 230B and 230C can be varied as appropriate to suit operational conditions.

In general terms, the appropriate axial length for soft banding molded onto a steel pipe (or solid rod) in accordance with the present disclosure will be determined by a number of factors, typically including the need for the interface between the soft-banding material and the metal surface of the pipe (or rod) to provide sufficient area for the application of a bonding agent to prevent failure of adhesion between the soft-banding material and the pipe (or rod) surface as a result of differential axial loads that can be expected under service conditions. Other factors in this regard include surface preparation prior to application of the bonding agent, as well as the particular soft-banding materials and bonding agents used. The effectiveness of the bond or anchorage of the soft banding to the steel tubing or rod optionally may be enhanced by texturing the surfaces of the tubing or rod, such as knurling or grooves machined into the steel surfaces to provide an element of mechanical interlock between the soft-banding material and the steel tubing or rod surfaces onto which it will be applied (such as by injection molding).

In one particular embodiment, the material used for soft banding may comprise a thermal polyurethane, such as “Avalon® 90 AB” or “Irogran® A 85 P 4441” (both of which are available from Huntsman Polymers Corp., of Odessa, Texas). In another embodiment, the soft-banding material may comprise a polyphthalamide PTFE (polytetrafluoroethylene) blend such as “MX-3038” (available from Modified Plastics, Inc., of Santa Ana, California). In other embodiments, the soft-banding material may comprise “PEEK” (polyether ether ketone) such as “Vestakeep® L 4000 G” (available from Evonik Industries AG, of Essen, Germany).

The materials listed above were tested under simulated downhole operating conditions using the testing apparatus described earlier herein, and proved to exhibit unexpectedly low wear compared to other materials that had previously tested with unsatisfactory results. Those unsatisfactory materials included A606 and A674 Fortron® MT® PPS (polyphenylene sulphide), and six polyketone blends. The differences were surprisingly dramatic:
A test piece of 2.875"-inch O.D. tubing having soft banding comprising polyphenylene sulphide was tested in the described testing apparatus with a steady side load of 1,000 pounds urging the tubing against the bore surface of the casing element mounted in the testing apparatus, with a steady flow of water-sand slurry containing 1% sand by weight. After 2.5 hours, the soft banding exhibited 100% wear (meaning loss of radial thickness down to the bottom of the 0.125-inch-deep wear measurement groove in the soft banding).
Similar test pieces, each having soft banding comprising one of the above-mentioned six polyketone blends, were tested in the same manner, and in the best result of these six test pieces, the soft banding exhibited 80% wear after 2.5 hours.
Similar test pieces having soft banding comprising thermal polyurethanes were then tested in the same manner. In the best result of these test pieces, the soft banding exhibited zero measurable wear after 2.5 hours, and the other tests yielded comparable results.
   The test piece that exhibited zero wear in the first test run was then retested with the side load increased to 1,500 pounds and with the sand content of the water-sand slurry increased to 2.5%. After five (5) hours of further testing under these conditions, the soft banding exhibited only 1% wear.
   The same test piece was then further retested with the same side load of 1,500 pounds, but with the sand content of the water-sand slurry increased to 5.0%. After eight (8) hours further hours of testing under these conditions, the soft banding exhibited only 3% total wear.

Other notable observations from the testing done on the test pieces with thermal polyurethane soft banding included measurements of casing wear. The measured wall thickness of the 5.50“-O.D. carbon-steel casing element prior to testing was 0.275”. After one hour of testing in the testing apparatus with an applied side load of 1,100 pounds, the measured reduction in casing wall thickness ranged from 0.003”to a maximum of 0.007”.

In contrast, the measured reduction in casing wall thickness after conducting the previously-mentioned benchmark testing of a test piece with conventional hard banding, under the same test conditions and for the same length of time, ranged from 0.034” to a maximum of 0.059”.

Based on these test results, it became apparent that soft banding comprising thermal polyurethane would provide outstanding wear resistance and service life during actual field conditions, while causing less casing wear and significantly reducing friction loads, thereby reducing the magnitude of torque necessary to rotate the tubing string inside the casing, with consequent beneficial effects in terms of operating and maintenance costs for associated surface equipment (e.g., top drives). It also became apparent from this testing program that soft banding using other synthetic materials (including but not limited to PTFE and PEEK) could reasonably be expected or predicted to provide very good wear resistance and service life as well.

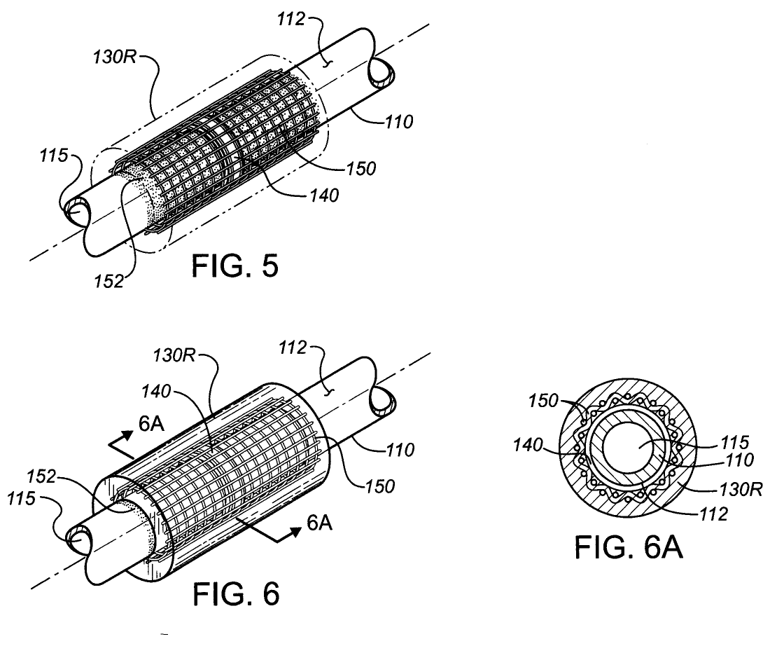

In variant embodiments, soft banding in accordance with the present disclosure may have embedded reinforcing materials, such as but not limited to mesh reinforcement embedded as illustrated in FIGS. 5, 6, and 6A. In the illustrated embodiments, a mesh cage 150 is positioned around a selected region of a circumferential surface 112 of a non-upset portion of a tubing joint 110, preferably with a suitable bonding agent 152 having been applied to the selected region. Mesh cage 150 may be made from any suitable metallic or non-metallic material (such as, by way of non-limiting example, stainless steel or glass fibers), and may comprise (by way of non-limiting example) a non-woven mesh as shown in FIGS. 5 and 6, or a woven mesh as shown in FIG. 6A.

Although not essential, one or more annular spacers 140 may be positioned around tubing joint 110 prior to placement of mesh cage 150 to provide clearance between mesh cage 150 and outer surface 112 of tubing 110.

Pull tests were performed on specimens of 2.875” O.D. pipe having 5-inch-long soft-banded wear pads, both with and without mesh reinforcing in accordance with the present disclosure. The mesh cage for the reinforced test specimens used a stainless steel mesh (304-Roll-Bare-6-0.035”), and the preparation of the pipe surfaces prior to the application of soft banding (by injection molding) was the same for both reinforced and unreinforced specimens. The pull tests were performed with the test specimens at a temperature of 150° F.

In the pull tests, the axial force needed to break the bond between the soft banding and the pipe surface (and thus allowing longitudinal displacement of the wear pads relative to the pipe) was measured as 1,200 pounds for the unreinforced test specimens. However, the required axial force increased to 3,800 pounds for the mesh-reinforced specimens.

It will be readily appreciated by persons skilled in the art that various modifications to embodiments in accordance with the present disclosure may be devised without departing from the present teachings, including modifications which may use structures or materials later conceived or developed. Although the specific embodiments illustrated and described herein are specific intended for use in oilfield operations, these specific embodiments are not intended to restrict or limit the scope of the present disclosure, which is intended to cover variant embodiments for use in non-oilfield-related fields.

It is to be especially understood that the scope of the present disclosure is not intended to be limited by or to any particular embodiments described, illustrated, and/or claimed herein, but should be given the broadest interpretation consistent with the disclosure as a whole. It is also to be understood that the substitution of a variant of a disclosed or claimed element or feature, without any substantial resultant change in functionality, will not constitute a departure from the scope of the disclosure or claims.

In this patent document, any form of the word “comprise” is intended to be understood in a non-limiting sense, meaning that any element or feature following such word is included, but elements or features not specifically mentioned are not excluded. A reference to an element or feature by the indefinite article “a” does not exclude the possibility that more than one such element or feature is present, unless the context clearly requires that there be one and only one such element or feature.

Any use of any form of the term “typical” is to be interpreted in the sense of being representative of common usage or practice, and is not to be interpreted as implying essentiality or invariability.

1. A method of protecting a tubing or solid rod component from abrasive wear, comprising the step of forming one or more circumferential wear bands of a selected polymeric material around the tubing or solid rod component at one or more selected locations along the length of the tubing or solid rod component.

2. The method as in claim 1 wherein the tubing or solid rod component has upset ends.

3. The method as in claim 2 wherein a circumferential wear band is applied to one of the upset ends of the tubing or solid rod component.

4. The method as in claim 1, wherein the selected polymeric material comprises a thermal polyurethane.

5. The method as in claim 1, wherein the selected polymeric material comprises a polyphthalamide PTFE (polytetrafluoroethylene) blend.

6. The method as in claim 1, wherein the selected polymeric material comprises a polyether ether ketone (PEEK).

7. The method as in claim 1, wherein the selected polymeric material is applied to the tubing or rod component by means of injection molding.

8. The method as in claim 1, wherein a bonding agent is applied to the tubing or rod component prior to forming the one or more circumferential wear bands.

9. The method as in claim 1, comprising the step of embedding a reinforcing material in the one or more circumferential wear bands.

10. The method as in claim 9 wherein the reinforcing material comprises a stainless steel mesh.

11. The method as in claim 9 wherein the reinforcing material comprises glass fibers.

12. A joint of tubing or solid rod having one or more circumferential wear bands formed in accordance with the method as in claim 1.

13. A joint of tubing or solid rod having one or more circumferential wear bands formed in accordance with the method as in claim 9.
